(19) United States
(12) Patent Application Publication
(10) Pub. No.: US 2007/0276929 A1
(43) Pub. Date: Nov. 29, 2007

(54) METHOD AND APPARATUS FOR TRACKING OPTICAL DISC USAGE DATA

(76) Inventors: Vincent Allen, New York, NY (US); Scott Wolynski, New York, NY (US)

Correspondence Address: SERIOUS USA, INC.;c/o TORYS LLP, SUITE 3000 , P.O.BOX 270, 79 WELLINGTON STREET WEST , TD CENTRE, TORONTO, ON, M5K 1N2, US

(21) Appl. No.: 11/753,278

(22) Filed: May 24, 2007

Related U.S. Application Data
(60) Provisional application No. 60/808,177, filed on May 24, 2006.

(51) Int. Cl. G06F 15/16

(52) U.S. Cl. 709/219

(57) ABSTRACT

A software tool, method and apparatus for recording data relating to optical discs is described. Optical disc tracking software may include a reporting component, a tracking component and a database component. A tracking component may reside on an optical disc, which can be of a standard or mini size and preferably is wallet-sized and has a non-circular shape. Data may be exchanged with a data server. A method and an apparatus providing similar aspects is also described.

### RELATED APPLICATION

This application claims the benefit of U.S. Provisional Patent Application Ser. No. 60/808,177, filed 24 May 2006 and entitled Method and Apparatus for Tracking Optical Disc Usage Data, the entire contents of which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY OF THE INVENTION

The present invention provides a software tool, method and apparatus for tracking data related to use of optical discs. A software tool according to the invention comprises optical disc tracking software including a reporting component, a tracking component and a database component. A tracking component may reside on an optical disc, which can be of a standard or mini size and preferably is wallet-sized and has a non-circular shape. Once a user inserts an optical disc with at least partial content encoded thereon into an optical disc reader, the tracking component records a user's behavior, such as for example the running time of a session or the number of times a user selects or otherwise activates a particular link. Upon receiving a prompt, such as for example a request from a user to close a program or data exchange session involving the optical disc, a tracking component communicates the recorded data, in addition to optional default data such as the title of the optical disc with which a user has been interacting, to a reporting component. A reporting component inserts data received by it into a database component having at least one database.

In various embodiments, data that may be tracked and communicated include a disc ID, disc name, user name, session duration (such as how long a disc was used, by session and/or cumulatively), timestamps (relating to access, use, and/or time of communication), the operating system used to access the disc, or location of a user or the computer used to access the disc (such as by reference to an IP address). The data that is tracked and communicated may also be customized, such as the number of times a user accessed a certain section, and for how long.

In various embodiments, the invention provides real-time and/or batch reporting of recorded data.

In various embodiments, by accessing a designated website, preferably through use of a username and password, an interested party can retrieve data from a database component according to various criteria programmed depending on that party's interests.

In various embodiments, software tools according to the invention can be configured to retrieve data according to specified criteria and provide electronic email or text alerting to a party's email, blackberry, cellular phone, or other mobile or other wireless, hand-held or web-enabled devices.

In various embodiments, components of a software tool according to the invention are designed as independent modules to allow for portability, scalability (as to the volume of data), modification, update and maintenance.

In various embodiments, software tools according to the invention do not need to be reprogrammed for individual projects.

In various embodiments, the invention provides for tracking of data for purposes of marketing and research and development. Such data can be mined according to various criteria specified by an interested party, such as for example criteria designed to show demographic and behavioral information. For example, if a corporate entity sells a gift card with promotional content thereon, a representative of that entity can access a designated website to obtain a data report regarding how many times certain promotional content encoded on, or accessed using data encoded on, the disc was accessed, for one or more geographic locations where users were most responsive to the promotional content; how many clicks or other commands originating from one or more discs according to the invention a specific website received within a specified time period, such as a day, a month, or an hour; which websites were most popular amongst users of such discs, and among which demographic segments of such users; and/or any other criteria of interest to the entity for research, marketing or other business purposes. Alternatively, such information can be pushed to the same or another entity in a form of an electronic alert.

In various embodiments, the invention can be used to track data for entertainment purposes, such as tracking high scores of a game; or tracking scores of several parties playing against each other; or tracking scores of the same player through multiple levels of a game, each level on a separate disc. In an embodiment, a tracking component on optical discs of several players can be configured to link these optical discs so that the optical discs are conscious of each other. For example, a software tool according to the invention can track scores of a single player through multiple levels of play, each accrued and/or stored using a separate optical disc; software tools according to the invention the invention can recognize related optical discs and adjust such players' scores depending on how many optical discs the players have bought; for example, earned points may be upwardly adjusted with the addition of each successive purchased optical disc related to the play; the more optical discs a player accumulates, the more points a player is enabled to score, and the more quickly a player can earn a prize. Alternatively, a player's scores can be tracked through several optical discs with related content thereon until a player reaches a prerequisite score to play against another player, wherein the outcome of the play would determine the winner of a prize.

Embodiments of the present invention are further discussed herein below.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of an embodiment of a system according to the invention.

FIG. 2 is a flow chart of an embodiment of an optical disc usage tracking method according to the invention.

FIG. 3 is a diagram of an embodiment of a system according to the invention.

### DESCRIPTION OF EMBODIMENTS OF THE INVENTION

As used herein, the term “session” refers to a distinct set of interactions with an optical disc, beginning from the time a user inserts an optical disc into an optical disc reader to the time that a user quits an optical disc such that it is no longer being read by an optical disc reader. The term “behavior” as used herein refers to the activity or activities which a user performs in relation to a program or programs accessed using an optical disc during a session. The term “target” as used herein refers to a subset of a user's behavior; for example, if an optical disc contains information regarding basketball players and a party would like to know which basketball player's biography received the most hits, that basketball player's biography is a target in relation to which a user's behavior is tracked. The term “hit” as used herein refers to each time a user interacts with a target, such as, for example, clicking on a web link or accessing certain content on an optical disc.

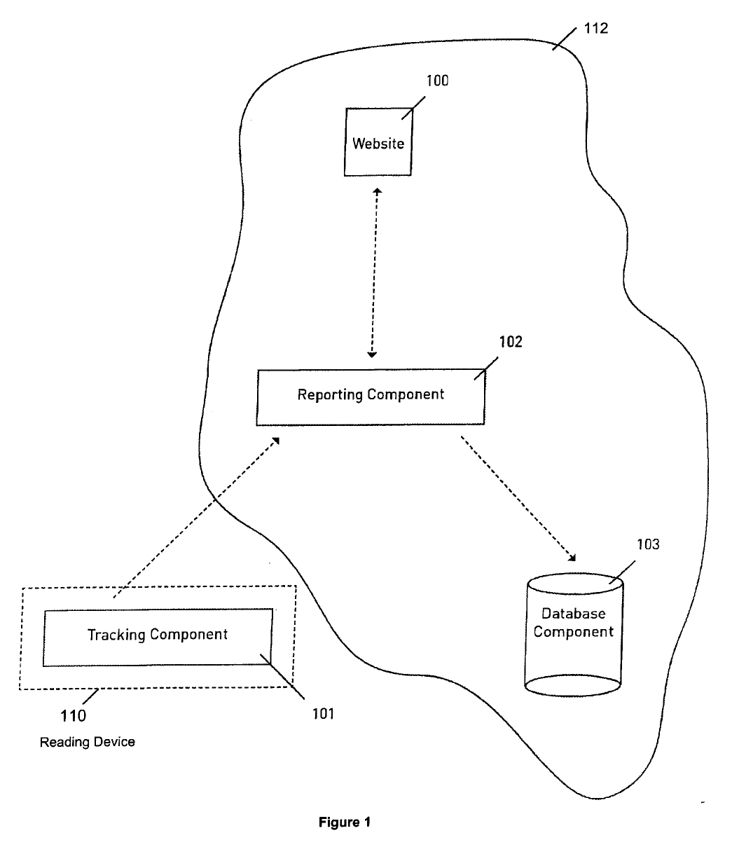

Referring to FIG. 1, an embodiment of a software tool of the present invention comprises optical disc tracking software, including tracking component 101 which is in communication with reporting component 102, and database component 103 comprising at least one database, in communication with the reporting component 102. In the embodiment shown in FIG. 1, reporting component 102 is in communication with a website 100 which can be accessed by an interested party to view optical disc usage data related to the activities of a single user or a plurality of users.

In the embodiment shown in FIG. 1, an optical disc according to the invention is inserted into a reader of a user computer 110 in communication with an electronic network 112 such as the Internet, the user computer having an optical drive reader by which an optical disc can be read; at least one network sever on which reporting component 102 and database component 103 reside; and an optical disc on which at least a portion of tracking component 101 resides. Optical discs in accordance with the invention can be of any size, shape, configuration, type or format that is compatible with being read by a suitable optical drive or other reader, which can be of any configuration, type or format, whether now known or later developed, compatible with the purposes disclosed herein. In particular, optical discs according to the invention can include wallet-sized non-round optical discs. Preferably, an optical disc of the present invention has at least partial content recorded thereon. In a preferred embodiment of this invention, an optical disc on which at least a portion of the tracking component 101 resides is wallet-sized (for example, the size of a credit card) and has a non-round shape. Such optical cards are beneficial, for example, for use in promotional purposes such as gift cards, credit or stored value cards, game cards, etc. A software tool of the present invention which allows a party to track a user's interaction with an optical card allows such and/or other parties to receive useful information in connection with all of these uses of optical cards, as well as other uses that will be apparent to one of ordinary skill in the art.

Tracking component 101, reporting component 102, and database component 103 of a software tool according to this invention can be created by any means known in the art, as will be apparent to those of ordinary skill in the art. As a non-limiting example, tracking component 101 can written in LINGO, reporting component 102 can be written in PHP or AJAX, and database component 103 can be written in MySQL database.

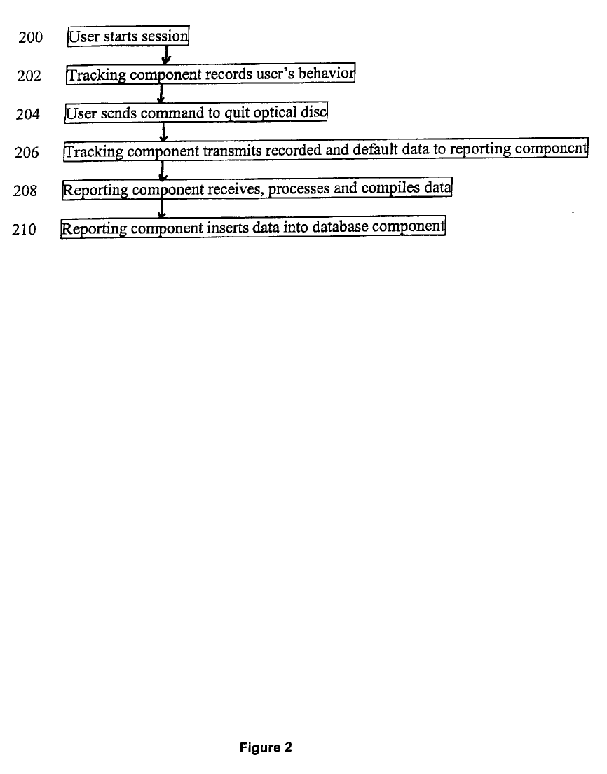

Referring to FIG. 2, at 200, a user starts a session, as for example by inserting a disc into a reader and thereby triggering auto-execution of code stored on the disc; and tracking component 101 begins to record the length of the session. At 202, tracking component 101 continues to track the user's behavior throughout the session by recording usage data as the user issues execution commands by, for example, activating hypertext or other links displayed using data stored on or accessed in accordance with instructions stored on the disc. For example, by means known to one of ordinary skill in the art, tracking component 101 records each time a user clicks a link to a particular website, or makes any hit with respect to any target.

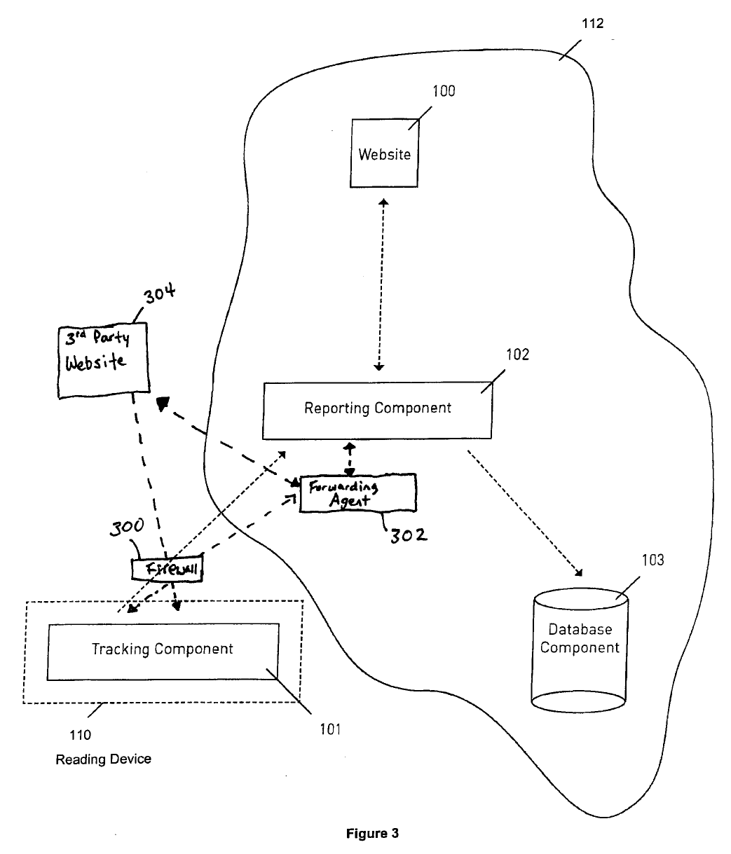

According to various embodiments of the invention, each link or request by a user is made initially through the same base Uniform Resource Locator (URL), such URL identifying a system or communication server operated by a merchant, an optical disc manufacturer, a system operator or another party who desires to track data associated with usage of the disc. Such a URL may further be associated with information, such as further URL data, that initiates or facilitates further actions to take or links to follow. The operator's system may then initiate such further action, operating as a forwarding agent, as shown in FIG. 3. An advantage offered by such a URL referral scheme is that a greater range of activities may be initiated by the user of the optical disc without being impeded by firewalls or other security features of addressee computers.

Further referring to FIG. 2, at 204, a user sends a request to quit the session involving the optical disc. At 206, the request prompts tracking component 101 to communicate with reporting component 102 and to transmit to reporting component 102 all data recorded during the session as well as any additional desired default data. According to an embodiment, the recorded data may be sent to a base URL, via the Internet or another port. The base URL may be the same one as at 202 or a different one. Sending recorded data, via the Internet, to a base URL may facilitate sending of data without impedance from a firewall or other security device, allowing data to be sent successfully and without altering a firewall. This can for example reduce potential security concerns.

Optional default data may include, for example, the title of an optical disc with which a user has interacted, the length of time that a user interacted with the optical disc, and/or information about the user's operating system. Those skilled in the relevant arts will understand that the software can be programmed such that the communication comprises other default data. When in communication with tracking component 101, reporting component 102 can retrieve a user's IP address. As is known in the art, geographic locations can be determined using an IP to location database that comprises a part of database component 103 and that is accessed when tracking component 101 communicates with reporting component 102.

At 208, reporting component 102 receives, processes and compiles all of the data received and retrieved by it and preferably makes a date/time stamp for when the communication from tracking component 101 occurred. At 210, reporting component 102 inserts such data into database component 103 having at least one database.

According to various embodiments of the invention, reporting component 102 can comprise two components, a third party component and an administrative component. A third party component allows an interested party, such as a user or a third party, to retrieve and view optical disc usage data relating to specific optical discs, sorted by various fields or criteria, by accessing website 100. Access to website 100 can be through a log-in utilizing a user name and a password or through any other means. An administrative component allows an administrator of a software tool of this invention to access website 100 to add, edit or delete optical discs with respect to which information is tracked; add, edit or delete users; and perform any other desired administrative functions.

Collected data may be viewed by an interested party in any number of desired formats and sorted by any number of desired categories. For example, an interested party may sort data relating to hits for a particular target according to hits by month, day, week, hour of day; session duration; number of sessions by operating system; top 25 (or other number) countries, regions, cities, IP addresses; and/or total countries, regions, and/or cities. Interested parties also may sort data relating to targets sorted by fields such as most popular target; or most popular target by month, sessions duration, country, region, city, etc. As will be apparent to those of ordinary skill in the relevant arts, other sorting categories and criteria can be programmed. An interested party may view the sorted data in any number of desired formats, including for example in tabular format or as a table, a bar graph, a pie graph, a line graph, etc. A printout of an embodiment of website 100 is attached hereto and referenced herein.

According to further embodiments of the invention, interested parties may specify the parameters according to which tracking data of optical disc usage is to be sorted, the desired report format, and a desired frequency of updates, and receive tracking data reports via electronic alerts to a web-enabled device, including a desk top or lap top computer, handheld devices, a mobile telephone, a blackberry, or any other web-enabled device.

According to various embodiments of the invention, software tool according to the invention provide real-time reporting of tracking data, according to any means known in the art.

According to various embodiments of the invention, tracking component 101, reporting component 102 and/or database component 103 are designed as portable modules. For example, tracking component 101 resides wholly or partially on an optical disk; reporting component 102 and database component 103 on a network server. A network server may for example be the server of an administrator of the software tool of this invention. In other embodiments, a network server may be the server of an interested party. For example, if a corporate client desires to use a software tool of this invention to track data on its own website, reporting component 102 and database component 103 modules can be easily moved (or copied) and installed to reside on a client's Internet server. Further, data stored in database component 103 may be stored in a universal format, allowing such data to be easily shared between reporting components on various servers. For example, if a third party is a corporate entity that already provides some form of reporting functionality, such third party can smoothly and easily integrate tracking data from database component 103 with the third party's own system. Such portability and flexibility of use allows a software tool of this invention to be a turn-key solution that can be easily adapted to any client and any need.

In various embodiments, a software tool of this invention does not need to be reprogrammed or otherwise adjusted to individual projects by writing a new software program for each new project. An interested party need only specify which optical disc or discs it desires to track and the data sorting parameters for the tracking report. Since a new software program does not need to be written for each new project, a software tool of this invention allows increased accuracy and efficiency in tracking data.

A software tool of this invention can be used in connection with many and varied applications. In various embodiments, software tools according to the invention can be used to help corporate entities or organizations to track data for purposes of marketing, research, or development. For example, a nation-wide or international merchant selling gift cards comprising optical discs that can fit into a wallet and that have interactive content thereon may desire to track data regarding end-user's usage of the optical gift cards, including which links were most frequently accessed, where geographically the gift cards were most widely used, etc. Using a software tool of this invention, such merchant will be able to track data with respect to an individual optical gift card or with respect to the merchant's entire series of optical gift cards; with respect to target user behavior or with respect to user behavior in particular geographic locations; or with respect to any other variant of user behavior of interest to such merchant. Such merchant may choose to access a website, whether its own or one run by a third party administrator, to receive tracking data reports with respect to the optical gift cards, or the merchant may choose to receive periodic electronic reports to a web-enabled device.

In various embodiments, a software tool of this invention can be used to track data in the entertainment sector. For example, a game can be devised where a player purchases an optical disc with a game wholly or partially encoded thereon. In the preferred embodiment, the optical disc is an optical card, of a size that would allow it to fit into a wallet, such as, for example, the size of a credit card. As the player plays the game, a software tool of this invention tracks the player's score and/or other data, and provides the player with electronic updates and/or allows the player to view the score through a designated website.

A software tool of this invention can be configured, by any means known in the art, to track other optical discs related to the same game and display the results so that all players see the relationship of their scores to one another. The rules of the game may for example state that each time a player buys a new optical disc with a related game, the score earned by the player will be upwardly adjusted, or another reward given to the player. Optical discs related to the game may be configured, by any means known in the art, such that they are linked together and electronically conscious of each other, allowing a software tracking tool of this invention to recognize when the player has purchased an additional optical disc related to the game and to adjust the player's score accordingly. Many variations of this game may be applied by using a software tool of the present invention. For example, after reaching a target score, a player may be allowed to purchase “collector's” or other special optical discs related to the game. As another variation, a player may be prevented from purchasing or otherwise obtaining certain particularly coveted optical discs related to the game until the player plays another and wins. In connection with these, and many other variations that will become apparent to one skilled in the art, the portability and flexibility of the software tool of this invention will allow for accurate, effective and easily manageable and viewable tracking of optical disc usage data.

Referring to FIG. 3, a software tool in accordance with an embodiment of the invention is shown. Like reference numerals correspond to like elements from FIG. 1. The software tool of FIG. 3 further comprises firewall 300, reporting agent 302 and third-party website 306.

The system of FIG. 3 is in some respects similar to that shown in FIG. 1, with the addition of firewall 300, which can be disposed between the tracking device and any one or more other components and/or targets of the system. In such embodiments, for example, any communication from the tracking component may be required to pass through firewall 300.

An example of such a communication occurs when a user clicks or otherwise activates a link to a particular website, or makes any hit with respect to any target. The resulting communication may be directed to a base URL that directs the communication to forwarding agent 302. The communication may further include URL data specifying a further action or link to obtain, such as to third party website 304. Forwarding agent 302 can then re-direct the communication to that website. This allows firewall 300 (or a user or administrator thereof) to make a single determination that the base URL is to be trusted, while allowing access to many third party websites 304 (such websites may be determined to be safe by forwarding agent 302). Alternatively, the communication may be directed immediately to third party website 304—firewall 300 would then determine the safety of each such website.

Another such communication occurs when tracking component 101 sends data recorded during the session to reporting component 102. This communication may be through a port other than 80 or 8080 that are typically used for connecting to the world-wide-web, resulting in the firewall potentially stopping the communication. According to another embodiment, this communication may be directed to a base URL (the same as above or different) that directs the communication either to forwarding agent 302 (and then on to reporting component 102) or directly to reporting component 102. The recorded data, and default data, may be appended to the base URL, such as with tags, for reporting component 102 or forwarding agent 302. This may allow such communication to pass through firewall 300 as the base URL is already deemed safe by firewall 300.

As will be apparent to those skilled in the relevant arts, the software tool of FIG. 3 can be used both for tracking data related to use of optical discs and to track data in the entertainment sector.

It will be understood that the specification is illustrative of the present invention and that other embodiments within the spirit and scope of the invention will suggest themselves to those skilled in the art. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. An optical disc comprising encoded software readable by an optical disc reader of a user computer, the encoded software comprising a tracking component configured to cause a processor to record data related to characteristics of a user of the disc and transmit the recorded characteristic data to a reporting component of a server.

2. The optical disc of claim 1 wherein the optical disc further comprises encoded instructions useable by a processor for causing a display associated with the user computer to display one or more selectable items, selection of which by a user causes a processor to access data stored in memory associated with a network address associated with the selected item.

3. The optical disc of claim 2 wherein the one or more selectable items comprise one or more of hyperlinks, software modules and image files.

4. The optical disc of claim 3, wherein the characteristic data comprise demographic data.

5. The optical disc of claim 4, wherein the demographic data comprise geographic location information.

6. The optical disc of claim 5 wherein the characteristic data further comprises at least one of:
a number of times the optical disc has been used;
an elapsed amount of time that the optical disc has been used for; and
a number of times the one or more selectable items were selected by the user.

7. The optical disc of claim 1 wherein the tracking component is configured to cause the processor to process response data received from the reporting component.

8. The optical disc of claim 7 wherein the response data is configured to cause a processor to provide signals adapted for causing display of data on a user interface that is viewable on the user computer.

9. The optical disc of claim 7 wherein the response data comprises at least one of a rank, a high score, entertainment data associated with at least one other disc, data indicating eligibility to obtain another optical disc, and data identifying a prize earned based on the points.

10. The optical disc of claim 1 wherein the tracking component is configured to transmit the characteristic data in real time.

11. The optical disc of claim 1 wherein data transmitted by the processor and associated with the optical disc is addressed to a base Uniform Resource Locator.

12. The optical disc of claim 1 wherein data to be transmitted to the disc is addressed to a base Uniform Resource Locator.

13. An optical disc comprising encoded software readable by an optical disc reader, the software comprising:
an entertainment purpose component and associated entertainment data; and
a tracking component configured to cause a processor to communicate the entertainment data to a reporting software component of a server.

14. The optical disc of claim 13, wherein the entertainment data comprises a score or a number of points provided by the entertainment purpose component.

15. The optical disc of claim 13 wherein the tracking component is configured to receive response data from the reporting component.

16. The optical disc of claim 15 wherein the response data comprises at least one of a rank, a high score, entertainment data associated with at least one other disc, data indicating eligibility to obtain another optical disc, and data identifying a prize earned based on the points.

17. The optical disc of claim 13 wherein the tracking component is configured to transmit usage data in real time.

18. The optical disc of claim 13 wherein data transmitted by the processor and associated with the optical disc is addressed to a base Uniform Resource Locator.

19. The optical disc of claim 13 wherein data to be transmitted to the disc is addressed to a base Uniform Resource Locator.

20. the optical disc of claim 13 wherein each of the entertainment purpose component and tracking component is modular.

21. A method of tracking use of an optical disc, the method performed by a computer processor in response to execution of commands encoded on the disc as software, the method comprising:
upon insertion into an optical disc reader of a user computer, initiating, by the optical disc, a user session;
recording characteristic data related to use of the disc during the usage session with a tracking component encoded at least partly on the optical disc;
upon termination of the user session, causing the computer processor to transmit the characteristic data to a reporting component on a server computer.

22. The method of claim 21, wherein the characteristic data comprise demographic data.

23. The method of claim 22, wherein the demographic data comprise geographic location information.

24. The method of claim 23 wherein the characteristic data comprises at least one of:
a number of times the optical disc has been used;
an elapsed amount of time that the optical disc has been used for;
a number of times the one or more selectable items were selected by the user; and
entertainment data.

25. The method of claim 24 further comprising processing response data received from the reporting component.

26. The method of claim 25 further comprising storing the received response data in a storage medium.

27. The method of claim 26 wherein the storage medium comprises the optical disc.

28. A computer usable medium or media having computer readable code embodied therein comprising:
a reporting software component configured to receive usage data from a computer reading an optical disc comprising an encoded software tracking component configured to cause a processor to record usage data; and
a database component configured to receive and store usage data from the reporting software component.

29. The computer usable medium or media of claim 28 wherein the reporting software component is configured to cause a processor to send data to the computer reading the disc, transmit data to a third party processor, send an alert to a third party, and cause display of a user interface on a display associated with the computer reading the disc.

30. The computer usable medium or media of claim 28 wherein the data transmitted to a third party processor comprises at least one of usage data, summary data, geographic data, and response data.

31. The computer usable medium or media of claim 29 wherein the alert includes data having at least one of usage data, summary data, geographic data, and response data, such portion being configurable by a recipient of the alert.

32. The computer usable medium or media of claim 29 wherein an alert is sent to a third party's email, wireless device, or network-enabled device.

33. The computer usable medium or media of claim 29 wherein user interface is configurable by a user of the interface.

34. The computer usable medium or media of claim 33 wherein the user interface comprises a web-page.

35. The computer usable medium or media of claim 34 wherein a user may configure data to be displayed, and a sorting of the data to be used in the display.

36. A computer usable medium or media having computer readable code embodied therein comprising:
a reporting software component configured to receive entertainment data from a user computer having an optical disc comprising encoded software readable by an optical disc reader of a user computer, the encoded software comprising an entertainment purpose component having entertainment data and a tracking component configured to receive entertainment data from the entertainment purpose component to send to the reporting component; and
a database component configured to receive and store entertainment data from the reporting software component.

37. The computer usable medium or media of claim 36 wherein the entertainment data comprises a score or a number of points.

38. The computer usable medium or media of claim 36 wherein the reporting software component is configured to cause a processor to send response data to the user computer, and provide signals adapted for causing display of response data on a user interface that is viewable by a user.

39. The computer usable medium or media of claim 38 wherein the response data comprises a rank, a high score, entertainment data from a second user, entertainment data from at least one other optical disc, entertainment data from a second user computer, data indicating eligibility for a new optical disc, or data indicating a prize earned based on the points.

40. A method for tracking optical disc usage data, the method performed by a processor executing an encoded software instruction set and comprising:
receiving over a network from a computer reading an optical disc data related to usage of the disc, the usage data comprising at least one of:
a number of times the optical disc has been used;
an elapsed amount of time that the optical disc has been used for;
a number of times the one or more selectable items were selected by the user; and
entertainment data; and
storing the usage data in a database component that is in communication with the reporting software component.

41. The method of claim 40 further comprising providing at least a portion of the usage data to a third party computer.

42. The method of claim 41 further comprising providing to the user computer or a third party computer data useable for displaying an interface comprising at least a portion of the usage data.

43. The method of claim 42 wherein the interface is configurable by a user of the interface.
